(19) United States
(12) Patent Application Publication
(10) Pub. No.: US 2025/0321003 A1
(43) Pub. Date: Oct. 16, 2025

(54) EXHAUST GAS COMPOSITION CHARACTERIZATION IN COMBUSTION SYSTEMS

(71) Applicant: Clean Connect AI, Inc., Windsor, CO (US)

(72) Inventors: David A. Conley, Windsor, CO (US); Emily Lynn Wilson, Edgewater, MD (US)

(21) Appl. No.: 19/176,594

(22) Filed: Apr. 11, 2025

Related U.S. Application Data
(60) Provisional application No. 63/632,645, filed on Apr. 11, 2024.

(51) Int. Cl. F23N 5/00; G01N 1/22; G01N 21/35

(52) U.S. Cl. CPC F23N 5/003; G01N 1/2258; G01N 21/35; F23N 2223/06; F23N 2223/08; F23N 2223/36; F23N 2223/48; F23N 2241/12; F23N 2900/05001; F23N 2900/05003

(57) ABSTRACT

Various embodiments of the present technology relate to emission monitoring. Some embodiments comprise an exhaust testing system to characterize exhaust gas composition. The exhaust testing system comprises a sampling system and a gas analyzer. The sampling system is coupled to an exhaust stack of a combustion system. The sampling system comprises a cage, sampling pipes, and valves. The cage is mounted to the opening of the exhaust stack. The sampling pipes are mounted to the cage. The sampling pipes capture exhaust gas generated by the combustion system and emitted through the opening of the exhaust stack. The valves control gas flow through the sampling pipes. The gas analyzer is coupled to the sampling pipes. The gas analyzer determines gas composition of the exhaust gas.

### CROSS-REFERENCE TO RELATED APPLICATIONS

This U.S. patent application claims priority to U.S. Provisional Patent Application 63/632,645 titled “EXHAUST GAS TESTING SYSTEM FOR HYDROCARBON EXTRACTION ENVIRONMENTS” which was filed on Apr. 11, 2024. U.S. Provisional Patent Application 63/632,645 is incorporated into this U.S. patent application in its entirety.

### TECHNICAL FIELD

Various embodiments of the present technology relate to emission monitoring, and more specifically, to characterizing exhaust gas compositions in combustion systems.

### BACKGROUND

Hydrocarbon extraction systems comprise machinery and equipment configured to extract petroleum, natural gas, and other chemicals for use in energy generation, heating, and chemical production applications. Hydrocarbon extraction systems comprise extraction equipment, transfer equipment, and storage equipment. The extraction equipment removes hydrocarbons from subterranean reservoirs. Examples of extraction equipment include drilling rigs and hydraulic fracturing devices. The transfer equipment transports the extracted hydrocarbons between different geographic locations. Examples of transfer equipment include pipelines and tanker trucks. The storage equipment stores hydrocarbons. Examples of storage equipment include bullet tanks and storage vessels.

When extracting, storing, or transferring natural gas or other gaseous hydrocarbons, pressure can accumulate in the hydrocarbon extraction, transfer, and storage equipment. To respond to excessive pressure, the hydrocarbon extraction system burns off the excess natural gas in a process referred to as flaring. During flaring, the natural gas reacts with oxygen and is converted to carbon dioxide and water which is expelled into the atmosphere. This reaction does not run to completion and unreacted natural gas is also expelled into the atmosphere. Environmental regulations dictate that the proportion of unreacted natural gas in flaring exhaust cannot exceed a threshold, typically 2%. The combustion systems that flare natural gas are designed to operate within the threshold set by these regulations. However, the combustion efficiency of these systems degrades over time due to wear and tear.

To ensure the combustion systems flare natural gas within the limit set by environmental regulations, human operators manually test the chemical composition of the exhaust gas. Manually testing flaring exhaust is dangerous to human operators. Moreover, the manual testing is not performed under normal operating conditions (e.g., when alleviating excess pressure). Unfortunately, conventional hydrocarbon extraction systems do not efficiently determine the chemical composition of flaring exhaust. Moreover, the hydrocarbon extraction systems do not effectively adjust gas/air ratios during combustion based on exhaust gas composition.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for emission monitoring in combustion systems. Some embodiments comprise an exhaust testing system to characterize exhaust gas composition. The exhaust testing system comprises a sampling system and a gas analyzer. The sampling system is coupled to an exhaust stack of a combustion system. The sampling system comprises a cage, sampling pipes, and valves. The cage is mounted to the opening of the exhaust stack. The sampling pipes are mounted to the cage. The sampling pipes capture exhaust gas generated by the combustion system and emitted through the opening of the exhaust stack. The valves control gas flow through the sampling pipes. The gas analyzer is coupled to the sampling pipes. The gas analyzer determines the gas composition of the exhaust gas.

Some embodiments comprise a method of operating an exhaust testing system to characterize exhaust gas composition. The method comprises capturing, by sampling pipes attached to a cage mounted to an exhaust stack of a combustion system, exhaust gas from the combustion system. The method further comprises providing, by the sampling pipes, the exhaust gas to a gas analyzer. The method further comprises determining, by the gas analyzer, a composition of the exhaust gas. The method further comprises indicating, by the gas analyzer, the composition of the exhaust gas to a controller. The method further comprises adjusting, by the controller, an input gas composition to the combustion system based on the composition of the exhaust gas.

Some embodiments comprise one or more non-transitory computer-readable media that store instructions to control exhaust gas composition of a combustion system. The instructions, in response to execution, cause a computing system comprising a processor to perform operations. The operations comprise obtaining, from a laser heterodyne radiometer, a measurement that indicates a proportion of unreacted natural gas in exhaust gas generated by the combustion system. The laser heterodyne radiometer receives the exhaust gas captured by carbon sampling pipes attached to a conical steel cage mounted to the opening of an exhaust stack of the combustion system. The laser heterodyne radiometer measures the proportion of unreacted natural gas in the exhaust gas. The operations further comprise comparing the proportion of unreacted natural gas in the exhaust gas to a threshold that indicates a maximum allowable proportion of unreacted natural gas in the exhaust gas. The operations further comprise determining that the proportion of unreacted natural gas in the exhaust gas exceeds the threshold based on the comparison. The operations further comprise generating signaling to adjust an input fuel-to-air ratio for the combustion system to reduce the proportion of unreacted natural gas in the exhaust gas. The operations further comprise transferring the signaling for delivery to the combustion system. The combustion system adjusts the input fuel-to-air ratio based on the signaling.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of an exhaust testing system.

FIG. 2 illustrates an example of sampling system in the exhaust testing system.

FIG. 3 illustrates an exemplary operation of the exhaust testing system.

FIG. 4 illustrates another exemplary operation of the exhaust testing system.

FIG. 5 illustrates an example of a natural gas flaring system.

FIG. 6 illustrates an example of a sampling system in the natural gas flaring system.

FIG. 7 illustrates an example of a laser heterodyne radiometer in the natural gas flaring system.

FIG. 8 illustrates an example of a power supply in the natural gas flaring system.

FIG. 9 illustrates an example of a control loop in the natural gas flaring system.

FIG. 10 illustrates an example of a computing system that may be used in accordance with various embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

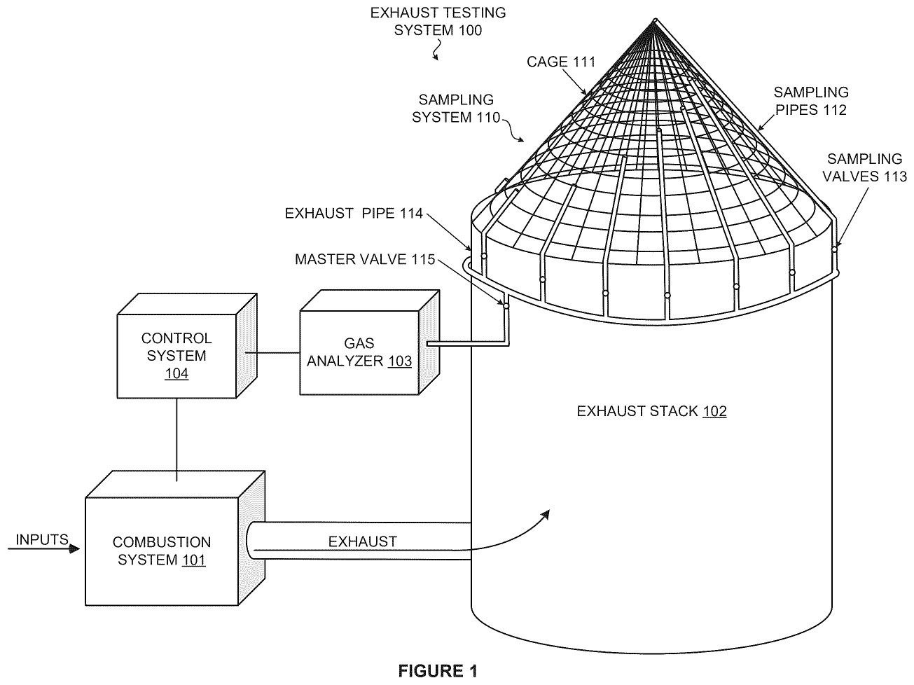

FIG. 1 illustrates exhaust testing system 100 to characterize gas composition in exhaust gas generated by combustion. Exhaust testing system 100 performs operations like controlling combustion inputs based on exhaust gas composition and determining exhaust gas composition in hydrocarbon flaring, chemical manufacturing, energy production, material processing, mining, and/or other environments that utilize combustion. Exhaust testing system 100 comprises combustion system 101, exhaust stack 102, gas analyzer 103, control system 104, and sampling system 110. Sampling system 110 comprises cage 111, sampling pipes 112, sampling valves 113, exhaust pipe 114, and master valve 115. In other examples, exhaust testing system 100 may include fewer or additional components than those illustrated in FIG. 1. Likewise, the illustrated components of exhaust testing system 100 may include fewer or additional components, assets, or connections than shown.

Various examples of system architecture and operation are described herein. In some examples, combustion system 101 ignites inputs and generates exhaust gas. Combustion system 101 expels the exhaust gas through exhaust stack 102. As the exhaust gas exits exhaust stack 102, sampling system 110 collects a portion of the gas. Sampling pipes 112 are mounted to cage 111 which is itself mounted to exhaust stack 102. Each of sampling pipes 112 comprise as inlet to collect the exhaust gas. When sampling valves 113 and master valve 115 are open, the exhaust gas passes through sample pipes 112 to exhaust pipe 114. Exhaust pipe 114 delivers the exhaust to gas analyzer 103. Gas analyzer 103 measures the composition of the exhaust gas and reports the composition results to control system 104. Control system 104 adjusts the inputs to combustion system 101 based on the reported gas composition. For example, control system 104 may adjust the fuel/air ratio to change the composition of the exhaust gas based on the reported gas composition.

Advantageously, exhaust testing system 100 efficiently determines the chemical composition of the exhaust gas. Moreover, exhaust testing system 100 effectively adjusts fuel/air ratios during combustion based on exhaust gas composition. By adjusting the fuel/air ratio based on exhaust gas composition, exhaust testing system 100 limits the amount of unreacted combustion inputs and/or undesired reaction side products that are expelled into the atmosphere. This reduces the number of pollutants (e.g., carbon monoxide (CO), nitric oxides (NO_{X}), hydrogen sulfide (H₂S), and sulfur oxides (SO_{X}), etc.) and harmful greenhouse gases (e.g., natural gas, methane (CH₄), ethane (C₂H₆), propane (C₃H₈), and butane (C₄H₁₀), etc.) that are released into the atmosphere. Furthermore, exhaust testing system 100 may further identify when combustion system 101 requires maintenance or needs replaced by tracking its combustion efficiency over time. Monitoring gas compositions in tandem with combustion system inputs may be used to optimize the combustion process by reducing products of incomplete combustion and reducing the amount of greenhouse gases that result from non-optimal burn conditions.

Combustion system 101 is representative of a chamber to combust the inputs into exhaust gas. The inputs typically comprise a liquid/gas fuel and an oxygen source (typically air). As the inputs flow into combustion system 101, combustion system 101 ignites the inputs which burn off to generate the exhaust gas. Combustion system 101 may be constructed from materials resistant to the high temperatures achieved during combustion (e.g., steel). In some examples, combustion system 101 is combined with exhaust stack 102. For example, exhaust stack 102 may be equipped with an electrical device that generates a spark to ignite the inputs. Exhaust stack 102 is representative of a channel to remove exhaust gas from combustion system 101. Exhaust stack 102 typically ranges between 1-5 feet in diameter, however the size of exhaust stack 102 is not limited.

Cage 111 is representative of the support structure for sampling system 110 and is mounted to the top of exhaust stack 102 where the exhaust gas is expelled into the atmosphere. Cage 111 comprises a set of interwoven axial and radial support members arranged in a conical shape. The axial support members comprise rods that are attached to the rim of exhaust stack 102 and extend to a point above exhaust stack 102 where they meet. The radial support members comprise rings of decreasing diameter that couple the axial support members to each other at intervals along the conical shape. Cage 111 is constructed from materials with sufficient strength to maintain the shape of cage 111 and support sampling pipes 112 as well as to withstand the elevated temperature of the exhaust gas. For example, the axial and radial support members of cage 111 may comprise steel rods and steel rings. It should be appreciated that the temperature profile of the exhaust gas varies along the cross-section of exhaust stack 102. Typically, exhaust gas exiting along the center of exhaust stack 102 is hotter than exhaust gas exiting along the rim of exhaust stack 102. As such, cage 111 is shaped like a cone to increase the distance between the support members that compose cage 111 and the hottest portion of the exhaust gas. However, the shape of cage 111 may differ in other examples. For example, cage 111 may be shaped like a disk and lie flat against exhaust stack 102.

Sampling pipes 112 are mounted to the axial support members of cage 111. Sampling pipes 112 are constructed from a material that can withstand the elevated temperature of the exhaust and that is chemically inert to the inputs and reaction products of combustion system 101. For example, sampling pipes 112 may comprise carbon tubes or quartz tubes. It should be appreciated that by being chemically inert to the reaction inputs and reaction products, sampling pipes 112 do not alter or minimally alter (e.g., via chemical reaction, catalysis, absorption, etc.) the chemical composition of the sampled exhaust gas before the sampled exhaust gas reaches gas analyzer 103. The top end of each of sampling pipes 112 comprises an inlet that allows the exhaust to enter sampling pipes 112 and pass to gas analyzer 103 through exhaust pipe 114. To facilitate exhaust gas collection, a pressure differential is created between the inlet of sampling pipes 112 and the atmosphere. For example, gas analyzer 103 may be equipped with a fan or vacuum pump to draw in exhaust through the inlets of sampling pipes 112. Sampling pipes 112 comprise different lengths and decrease in length from the right-hand side to left-hand side of cage 111. As illustrated in FIG. 1, the sampling pipe on the right-hand side of cage 111 extends to the top of cage 111 while the sampling pipe on the left-hand side of cage 111 extends to just above the rim of exhaust stack 102. It should be appreciated that the chemical composition of the exhaust gas may vary along the cross-section of exhaust stack 102 based on factors like combustion temperature and input component ratios. By varying the length of sampling pipes 112, sampling system 110 may collect exhaust gas at different points along the cross-section of exhaust stack 102 to determine how (and if) the chemical composition of the exhaust varies along the cross-section of exhaust stack 102.

The bottom ends of sampling pipes 112 are coupled to exhaust pipe 114. Exhaust pipe 114 is typically constructed from the same material as sampling pipes 112. Sampling valves 113 are attached to each of sampling pipes 112 above their connections to exhaust pipe 114. Sampling valves 113 are positioned below the opening of exhaust stack 102 to inhibit sampling valves 113 from overheating. Sampling valves 113 may comprise solenoids, ball valves, and the like. Sampling valves 113 control fluid flow though sampling pipes 112. This control allows sampling system 110 to selectively capture exhaust gas along the cross-section of exhaust stack 102. For example, if an operator wishes to determine the exhaust composition at a given point along the cross-section of exhaust stack 102, control system 104 may transfer signaling to open one of sampling valves 113 on the sampling pipe that corresponds to that point while leaving other ones of sampling valves 113 closed. Master valve 115 is attached to exhaust pipe 114 and controls fluid flow though all of sampling pipes 112. Master valve 115 comprises a solenoid, ball valve, and the like. Master valve 115 may be closed when sampling system 110 is not in use.

Gas analyzer 103 receives exhaust gas captured by sampling system 110. Gas analyzer 103 tests the exhaust to determine the chemical composition of the exhaust. Gas analyzer 103 comprises processing circuitry and measurement instruments to determine chemical compositions of gas. Gas analyzer 103 may comprise an infrared gas analyzer, a spectroscope, a radiometer, a laser heterodyne radiometer, and/or another type of gas sensing technology. Gas analyzer 103 provides gas composition data to control system 104. In particular, gas analyzer 103 detects the presence and amount of unreacted combustion inputs and unwanted side reaction products in the exhaust. Control system 104 is representative of a control unit that governs combustion within combustion system 101. Control system 104 may comprise a Programmable Logic Controller (PLC), a Proportional-Integral-Derivative (PID) controller, a machine learning based controller, and the like. For example, control system 104 may adjust the fuel/air ratio in the inputs to combustion system 101 based on the reported gas composition to achieve a desired exhaust gas composition.

Combustion system 101, valves 113 and 115, gas analyzer 103, and control system 104 communicate over various wireline and/or wireless networking protocols. The communication links comprise metallic links, glass fibers, radio channels, or some other communication media. Combustion system 101, valves 113 and 115, gas analyzer 103, and control system 104 may comprise microprocessors, software, memories, transceivers, bus circuitry, and the like. The microprocessors comprise Central Processing Units (CPUs), Graphical Processing Units (GPUs), Digital Signal Processors (DSPs), Application-Specific Integrated Circuits (ASICs), Field Programmable Gate Arrays (FPGAs), analog computing circuits, and/or the like. The memories comprise Random Access Memory (RAM), flash circuitry, Hard Disk Drives (HDDs), Solid State Drives (SSDs), Non-Volatile Memory Express (NVMe) SSDs, and/or the like. The memories store software like operating systems, gas analysis applications, control applications, and the like. The microprocessors retrieve the software from the memories and execute the software to drive the operation of exhaust testing system 100 as described herein.

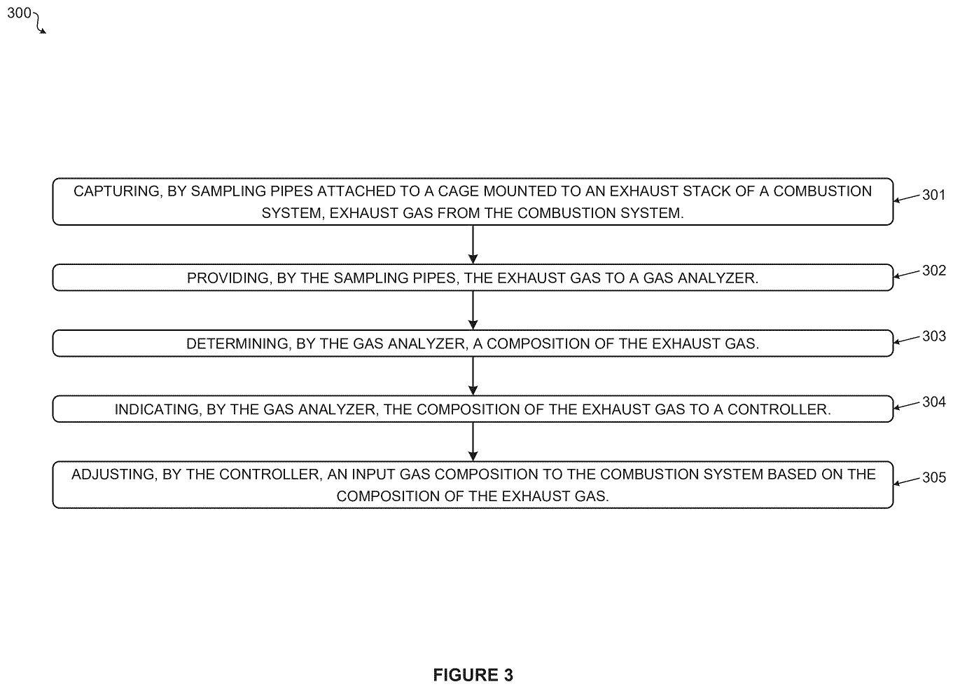

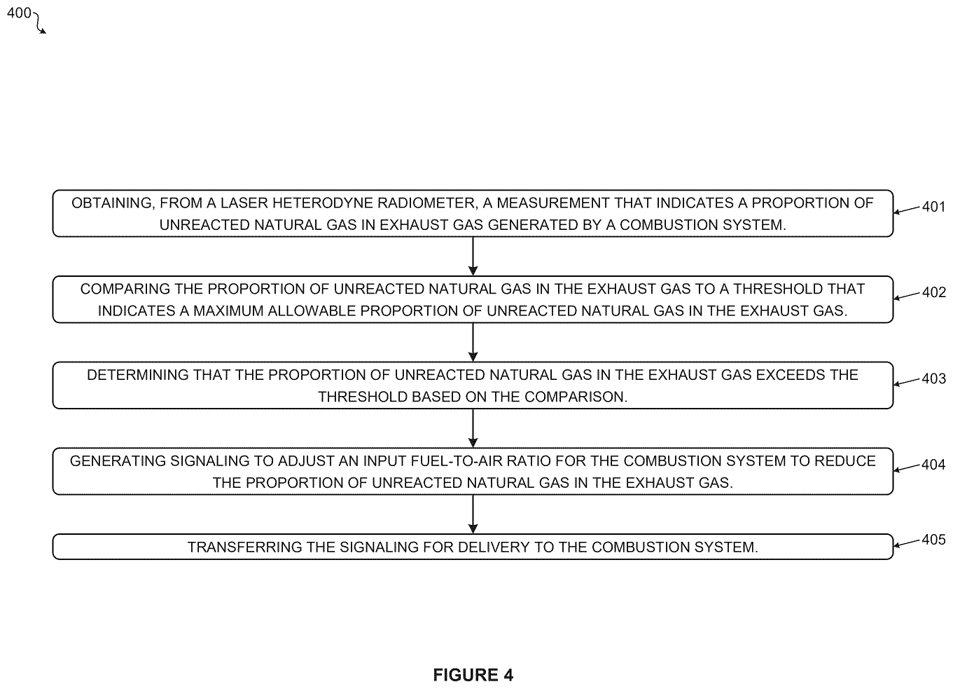

In some examples, exhaust testing system 100 implements process 300 illustrated in FIG. 3 and/or process 400 illustrated in FIG. 4. It should be appreciated that the structure and operation of exhaust testing system 100 may differ in other examples.

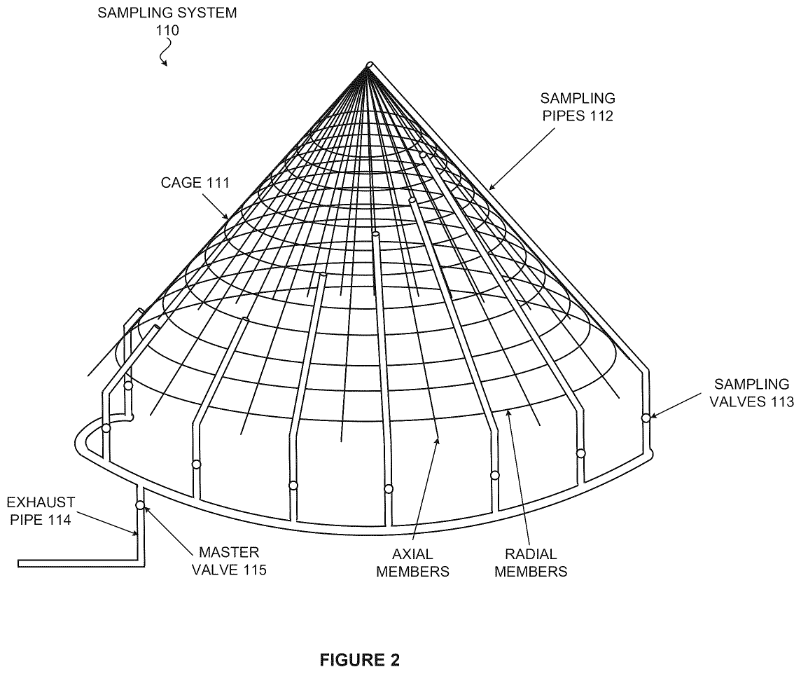

FIG. 2 further illustrates sampling system 110. As illustrated in FIG. 2, the axial and radial support members of cage 111 are arranged to form a cone. Sampling pipes 112 are fixed to the axial support members of cage 111. Sampling pipes 112 decrease in length from right to left along cage 111. Sampling valves 113 are coupled to each of sampling pipes 112 and control exhaust collection through their respective pipes. Each of sampling pipes 112 is coupled to exhaust pipe 114 which delivers the collected exhaust gas to gas analyzer 103. Master valve 115 is coupled to exhaust pipe 114 and controls gas flow for sampling system 110.

FIG. 3 illustrates process 300. Process 300 comprises an exemplary exhaust gas testing process. Portions of process 300 may be implemented in program instructions in the context of one or more software applications of one or more computing devices. In other examples, process 300 may differ. The operations of process 300 comprise capturing, by sampling pipes attached to a cage mounted to an exhaust stack of a combustion system, exhaust gas from the combustion system (step 301). The operations further comprise providing, by the sampling pipes, the exhaust gas to a gas analyzer (step 302). The operations further comprise determining, by the gas analyzer, a composition of the exhaust gas (step 303). The operations further comprise indicating, by the gas analyzer, the composition of the exhaust gas to a controller (step 304). The operations further comprise adjusting, by the controller, an input gas composition to the combustion system based on the composition of the exhaust gas (step 305).

Referring back to FIG. 1, exhaust testing system 100 includes a brief example of process 300 as employed by the various mechanical, computing hardware, and software components of exhaust testing system 100. In some examples, combustion system 101 receives air and fuel as inputs. Exemplary fuels include natural gas or other petroleum products. Combustion system 101 sparks the fuel/air mixture to initiate the combustion of the fuel. The combustion generates an exhaust gas comprising one or more reaction products. During combustion, a portion (e.g., 0.1-10%) of the fuel input remains unreacted. For example, in the case where the inputs comprise natural gas and air, the combustion reaction generates water (H₂O) and carbon dioxide (CO₂) and the resulting exhaust gas will comprise air, water, carbon dioxide, and unreacted natural gas. Combustion system 101 passes the exhaust gas (including the portion of unreacted inputs) to exhaust stack 102. The exhaust flows up exhaust stack 102 and is expelled into the atmosphere.

As exhaust stack 102 is expelling the exhaust gas, an operator initiates an exhaust testing process. The operator may be representative of a human or automated machine (e.g., a machine learning assisted controller). In response to the input, control system 104 transfers control signaling to open master valve 115. Control system 104 selects one of sampling pipes 112 and transfers control signaling to open the one of sampling valves 113 coupled to the selected pipe. Once both valves are open, control system 104 activates a fan (not illustrated) coupled to exhaust pipe 114. The fan may be a subcomponent of gas analyzer 103 or may be located somewhere else within exhaust testing system 100. The fan creates a pressure differential at the inlet of the open one of sampling pipes 112. The pressure differential causes exhaust gas flowing out of exhaust stack 102 to be captured by sampling system 110 (step 301). The exhaust gas flows through the open one of sampling pipes 112 and exhaust pipe 114 where it enters gas analyzer 103 (step 302). Gas analyzer 103 measures the exhaust gas to determine the chemical composition of the exhaust gas (step 303) and reports the chemical composition to control system 104 (step 304). Control system 104 saves the composition to memory in association with the selected one of sampling pipes. Once saved, control system 104 selects a new one of sampling pipes 112. Control system 104 transfers control signaling to close the one of sampling valves 113 coupled to the originally selected pipe and transfers control signaling to open the one of sampling valves 113 coupled to the newly selected pipe. Control system 104 repeats the above process for each of sampling pipes 112 to sample the exhaust gas along the cross-section of exhaust stack 102.

After the exhaust gas has been sampled through each of sampling pipes 112 individually, control system 104 transfers signaling to open all of sampling valves 113. The fan creates a pressure differential at the inlet at all of sampling pipes 112 causing the exhaust gas flowing out of exhaust stack 102 to be captured. The exhaust gas flows through all of sampling pipes 112 and exhaust pipe 114 where it enters gas analyzer 103. Gas analyzer 103 measures the exhaust gas to determine the bulk chemical composition of the exhaust gas and reports the bulk chemical composition to control system 104. The bulk chemical composition indicates the total proportion of unreacted combustion input as well as any side reaction products in the exhaust gas.

Once sampling is complete, control system 104 transfers control signaling to deactivate the fan and close sampling valves 113 and master valve 115. Control system 104 determines the chemical composition of the exhaust gas along the cross-section of exhaust stack 102 based on the associations between sampling pipes 112 and the reported chemical compositions. Control system 104 may report the cross-sectional chemical composition to operators to diagnose mechanical issues in combustion system 101 and/or exhaust stack 102. Control system 104 compares the total proportion of unreacted input to a threshold. For example, the threshold may set a limit that no more the 2% of the exhaust gas may comprise unreacted inputs. When the total proportion of unreacted inputs exceeds the threshold, control system 104 transfers signaling to combustion system 101 to modify the fuel/air ratio to reduce the proportion of uncreated inputs in the exhaust gas (step 305). For example, the signaling may direct combustion system 101 to reduce the fuel flow rate, increase the air flow rate, and the like. When the total proportion of unreacted inputs does not exceed the threshold, control system 104 maintains the current fuel/air ratio.

Combustion system 101 receives the signaling from control system 104 and modifies the fuel/air ratio of the inputs accordingly. Combustion system 101 generates additional exhaust gas using the new fuel/air mixture. As combustion system 101 generates the additional exhaust gas, control system 104 repeats the above-described gas sampling process to determine the chemical composition of the additional exhaust gas thereby forming a control loop. The operators may utilize the control loop to maintain the proportion of unreacted combustion inputs below the threshold. The operators may further utilize the chemical composition of the exhaust gas along the cross-section of exhaust stack 102 to diagnose problems in combustion system 101 and exhaust stack 102.

FIG. 4 illustrates process 400. Process 400 comprises an exemplary exhaust gas composition control process. Portions of process 400 may be implemented in program instructions in the context of one or more software applications of one or more computing devices. Process 400 comprises an example of process 300 illustrated in FIG. 3, however process 300 may differ. In other examples, process 400 may differ. The operations of process 400 comprise obtaining, from a laser heterodyne radiometer, a measurement that indicates a proportion of unreacted natural gas in exhaust gas generated by a combustion system (step 401). The laser heterodyne radiometer receives the exhaust gas captured by carbon sampling pipes attached to a conical steel cage mounted to the opening of an exhaust stack of the combustion system. The laser heterodyne radiometer measures the proportion of unreacted natural gas in the exhaust gas. The operations further comprise comparing the proportion of unreacted natural gas in the exhaust gas to a threshold that indicates a maximum allowable proportion of unreacted natural gas in the exhaust gas (step 402). The operations further comprise determining that the proportion of unreacted natural gas in the exhaust gas exceeds the threshold based on the comparison (step 403). The operations further comprise generating signaling to adjust an input fuel-to-air ratio for the combustion system to reduce the proportion of unreacted natural gas in the exhaust gas (step 404). The operations further comprise transferring the signaling for delivery to the combustion system (step 405). The combustion system adjusts the input fuel-to-air ratio based on the signaling. In some examples, process 400 may repeat.

Referring back to FIG. 1, exhaust testing system 100 includes a brief example of process 400 as employed by the various mechanical, computing hardware, and software components of exhaust testing system 100. In some examples, the inputs to combustion system 101 comprise natural gas and air, gas analyzer 103 comprises a laser heterodyne radiometer, sampling pipes 112 comprise carbon sampling pipes, and cage 111 comprises a steel cage. Combustion system 101 ignites the natural gas and air to generate exhaust gas. A proportion of the exhaust gas comprises unreacted natural gas. Combustion system 101 expels the exhaust gas to the atmosphere through exhaust stack 102. Sampling pipes 111 capture the exhaust gas emitted by exhaust stack 102 and provide the exhaust gas to gas analyzer 103. Gas analyzer 103 measures the proportion of unreacted natural gas in the exhaust gas. Gas analyzer 103 transfers a measurement that indicates the proportion of unreacted natural gas in the exhaust gas to control system 104.

Control system 104 obtains the measurement from gas analyzer 103 (step 401). Control system 104 compares the measured proportion of unreacted natural gas to a threshold that indicates a maximum allowable proportion of natural gas in the exhaust (step 402). For example, the threshold may set a limit of 1% of the exhaust gas may comprise unreacted natural gas. Control system 104 determines the proportion of unreacted natural gas in the exhaust exceeds the threshold based on the comparison (step 403). In response, control system 104 selects a new fuel-to-air ratio for combustion system 101. For example, control system 104 may host a data structure that correlates natural gas-to-air ratios with exhaust gas compositions. The data structure may consider factors like empirical data, combustion chamber temperature, pressure, humidity, and the like to correlate natural gas-to-air ratios with exhaust gas compositions. Control system 104 may input a desired exhaust gas composition into the data structure which then outputs a correlated natural gas-to-air ratio. Control system 104 generates signaling that indicates the selected fuel-to-air ratio to reduce the proportion of unreacted natural gas in the exhaust gas (step 404) and transfers the signaling to combustion system 101 (step 405). Combustion system 101 adjusts its input fuel-to-air ratio based on the signaling. For example, the signaling may drive actuators in combustion system 101 to adjust valves that control the input flowrate of natural gas and air to achieve the desired fuel-to-air ratio.

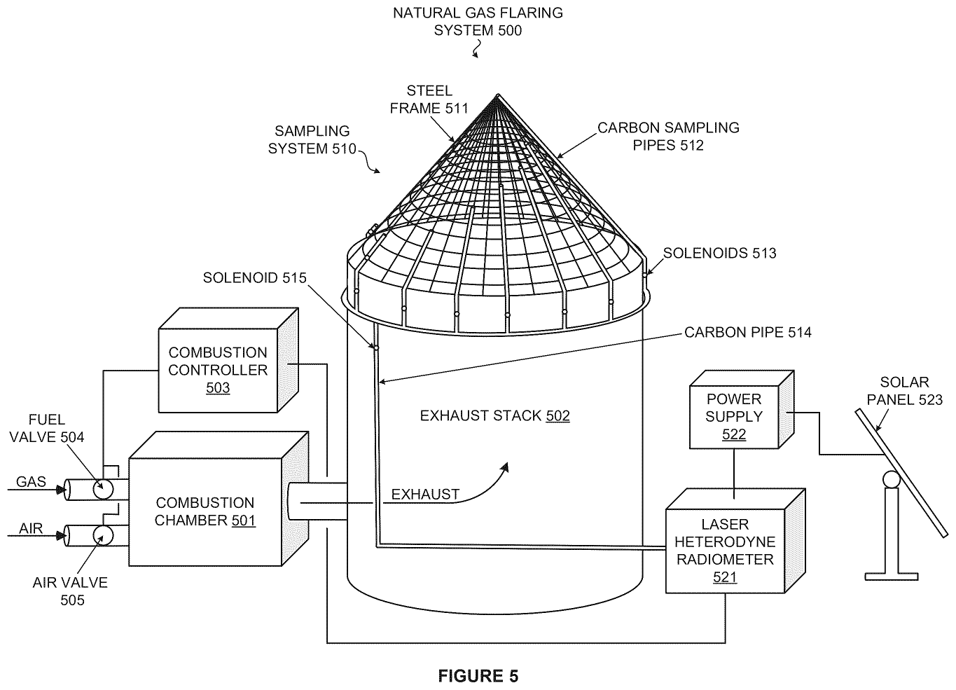

FIG. 5 illustrates natural gas flaring system 500. Natural gas flaring system 500 comprises an example of exhaust testing system 100 illustrated in FIG. 1, however exhaust testing system 100 may differ. Natural gas flaring system 500 comprises combustion chamber 501, exhaust stack 502, combustion controller 503, fuel valve 504, air valve 505, sampling system 510, laser heterodyne radiometer 521, power supply 522, and solar panel 523. Sampling system 510 comprises steel frame 511, carbon sampling pipes 512, solenoids 513, carbon pipe 514, and solenoid 515. In other examples, natural gas flaring system 500 may include fewer or additional components than those illustrated in FIG. 5. Likewise, the illustrated components of natural gas flaring system 500 may include fewer or additional components, assets, or connections than shown.

In some examples, an event occurs in natural gas flaring system 500 requiring natural gas to be flared. For example, natural gas flaring system 500 may be associated with a natural gas storage facility or hydraulic fracturing site that is experiencing an excess of natural gas. The excess gas results in an increase in pressure that surpasses the pressure capacity of the associated system. In response, an operator activates natural gas flaring system 500 to burn off the excess gas thereby alleviating the pressure in associated system. The operator may be a human or an automated device (e.g., dead man switch, a machine learning assisted controller, PLC, PID controller, etc.).

In response to the input from the operator, combustion controller 503 transfers control signaling to open fuel valve 504 and air valve 505. Combustion chamber 501 receives natural gas and air. Natural gas is a hydrocarbon gas mixture and primarily comprises methane (CH₄) at around 97% by volume. The remainder comprises other hydrocarbons like ethane (C₂H₆), propane (C₃H₈), and butane (C₄H₁₀) as well as trace amounts of carbon dioxide, nitrogen, hydrogen sulfide, and helium. Combustion chamber 501 provides a spark that ignites the gas/air mixture. The resulting combustion reacts the oxygen (from the air) and methane (and other hydrocarbons) to form carbon dioxide and water. However, the reaction is not 100% efficient and a portion of the input natural gas is not combusted. The inefficiency is a result of a suboptimal gas/air ratio, flow rate, combustion chamber shape/size, combustion chamber temperature, defects in combustion chamber 501, and the like. As such, the resulting exhaust gas comprises carbon dioxide, water, air, unreacted natural gas, and potentially other undesired reaction side products like carbon monoxide, nitric oxides, hydrogen sulfide, and sulfur oxides (SO_{X}). The unreacted natural gas typically forms between 0.1-10% of the exhaust gas. Combustion chamber 501 transfers the exhaust gas to exhaust stack 502. The exhaust gas travels up exhaust stack 502 and is expelled into the atmosphere.

Solar panel 523 absorbs sunlight and delivers current to power supply 522. Power supply 522 delivers current to laser heterodyne radiometer 521 (and potentially other components like solenoids 513 and 515). As combustion chamber 501 ignites the natural gas, combustion controller 503 transfers control signaling to open solenoid 515. Combustion controller 503 transfers additional control signaling to sequentially open and close solenoids 513. The communication links between combustion controller 503 and solenoids 513 and 515 are omitted for clarity. Combustion controller 503 transfers control signaling to laser heterodyne radiometer 521 to activate a fan operatively coupled carbon pipe 514. Carbon sampling pipes 512 comprise inlets near or at their top ends. The inlets allow exhaust gas emitted by exhaust stack 502 to enter carbon sampling pipes 512. The fan in laser heterodyne radiometer 521 creates a pressure differential at the inlet open one of carbon sampling pipes 512. The pressure differential causes exhaust gas to flow into the open one of carbon sampling pipes 512, down carbon pipe 514, and enter laser heterodyne radiometer 521.

Laser heterodyne radiometer 521 receives the sampled exhaust gas via carbon pipe 514. Laser heterodyne radiometer 521 measures the chemical composition of the sampled exhaust gas. To determine the chemical composition, laser heterodyne radiometer 521 applies infrared light to the exhaust gas and then measures the resulting absorption spectrum. Chemicals absorb more infrared light at particular wavelengths. Different types of chemicals absorb more infrared light at different wavelengths. For example, the wavelength absorption spectra for methane is different than the wavelength absorption spectra for oxygen. Laser heterodyne radiometer 521 processes the absorption spectrum at absorption wavelengths associated with methane, carbon dioxide, oxygen, nitrogen, water, and potentially other chemicals to correlate the amount of absorbed infrared light at these wavelengths to amounts of these chemicals in the exhaust gas. Laser heterodyne radiometer 521 reports the determined chemical composition to combustion controller 503. Combustion controller 503 receives the chemical compositions from laser heterodyne radiometer 521 for each of carbon sampling pipes 512 and stores the compositions in association with the corresponding ones of carbon sampling pipes 512.

Once the exhaust gas has been sampled through each of carbon sampling pipes 512, combustion controller 503 transfers control signaling to open all of solenoids 513. The fan in laser heterodyne radiometer 521 draws in the exhaust through all of carbon sampling pipes 512. Laser heterodyne radiometer 521 measures the exhaust to determine its bulk chemical composition. Laser heterodyne radiometer 521 reports the bulk chemical composition to combustion controller 503. The bulk chemical composition indicates the proportion of methane, nitrogen, oxygen, carbon dioxide, and any trace gases, unreacted reaction inputs, and/or side reaction products. Combustion controller 503 determines the chemical composition of the exhaust gas along the cross-section of exhaust stack 502 based on the associations between carbon sampling pipes 512 and the reported chemical compositions. When the cross-sectional chemical composition is not uniform or exceeds a threshold, combustion controller 503 may report the cross-sectional chemical composition to operators to diagnose mechanical issues in combustion chamber 501 and/or exhaust stack 502.

Combustion controller 503 compares the total proportion of methane in the exhaust to a methane gas threshold. For example, the threshold may set a limit that no more the 2% of the exhaust gas may comprise methane. When the total proportion of methane exceeds the threshold, combustion controller 503 selects a new gas/air ratio to reduce the proportion of methane in the exhaust. For example, combustion controller 503 may increase the air flow rate or decrease the gas flowrate to drive the reaction towards completion. Combustion controller 503 may also determine if any reaction side products like hydrogen sulfide, nitric oxides, and sulfur oxides exceed threshold values and may adjust the gas/air ratio to reduce the proportion of side products. For example, when the air flow rate is too high, the excess of nitrogen may result in the creation of nitric oxides. Combustion controller 503 transfers signaling to adjust fuel valve 504 and/or air valve 505. Valves 504 and/or 505 open/close in response to the control signaling thereby modifying the air and gas flowrate into combustion chamber 501 to achieve the new gas/air ratio.

Combustion chamber 501 receives natural gas and air at the new gas/air ratio and combusts the oxygen from the air and the methane to form carbon dioxide and water. The resulting exhaust gas comprises carbon dioxide, water, air, and a new proportion of unreacted natural gas (and potentially a new proportion of side-reaction products and/or other unreacted reaction inputs). Combustion chamber 501 transfers the exhaust gas to exhaust stack 502 which travels up exhaust stack 502 and is expelled into the atmosphere. Combustion controller 503 and laser heterodyne radiometer 521 repeat the above-described gas sampling process to determine the chemical composition of the exhaust gas generated using the new fuel/air ratio thereby forming a control loop. Operators may utilize the control loop to maintain the proportion of unreacted natural gas and reaction side products in the exhaust below the threshold. The operators may further utilize the reported combustion efficiency and the chemical composition of the exhaust gas along the cross-section of exhaust stack 502 to diagnose problems in combustion chamber 501 and exhaust stack 502.

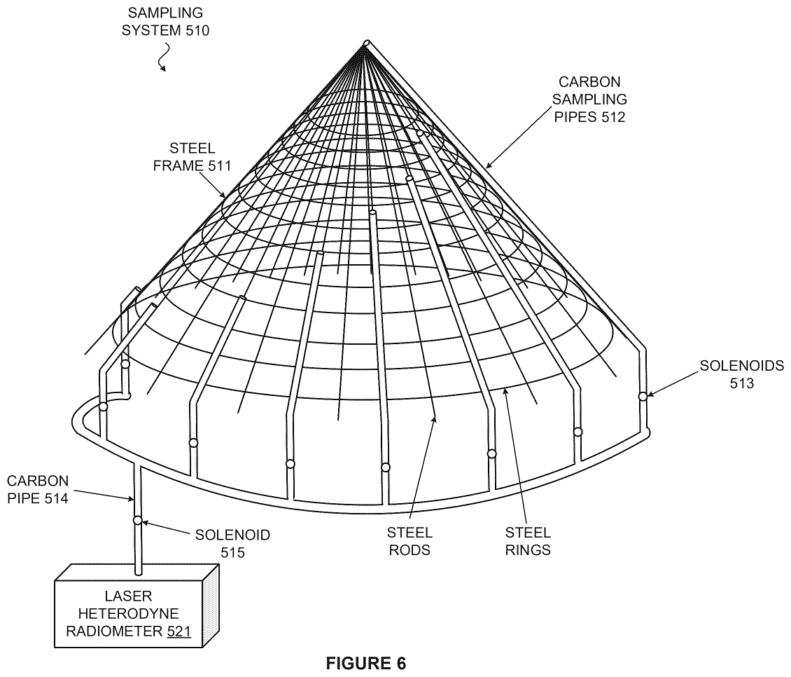

FIG. 6 illustrates sampling system 510. Sampling system 510 comprises an example of sampling system 110 illustrated in FIG. 2, however sampling system 110 may differ. As illustrated in FIG. 6, steel frame 511 comprises steel rods and steel rings of various diameters arranged to form a cone. Carbon sampling pipes 512 are mounted to the rods of steel frame 511. Carbon sampling pipes 512 decrease in length from right to left along steel frame 511. Solenoids 513 are coupled to each of carbon sampling pipes 512 and control exhaust collection through their respective pipes. Each of carbon sampling pipes 512 is coupled to carbon pipe 514 which delivers the collected exhaust gas to laser heterodyne radiometer 521. Solenoid 515 is coupled to carbon pipe 514 and controls exhaust flow for sampling system 510. Although steel frame 511 is illustrated comprising steel rods/rings, steel frame 511 may be constructed from another material with sufficient strength to support steel frame 511 and carbon sampling pipes 512 as well as withstand the elevated temperature of the exhaust gas. For example, the rods/rings of steel frame 511 may instead be constructed from an aluminum/steel alloy. Carbon sampling pipes 512 comprise hollow cylinders constructed from carbon (e.g., graphite). In alternative examples, carbon sampling pipes 512 may instead comprise quartz pipes or may be constructed from some other material that can withstand the temperature of the exhaust gas and that is chemically inert with respect to the environment, the reaction inputs, and the exhaust. Solenoids 513 and 515 comprise electronic valves that may be remotely operated from a control station (e.g., combustion controller 503 or laser heterodyne radiometer 521).

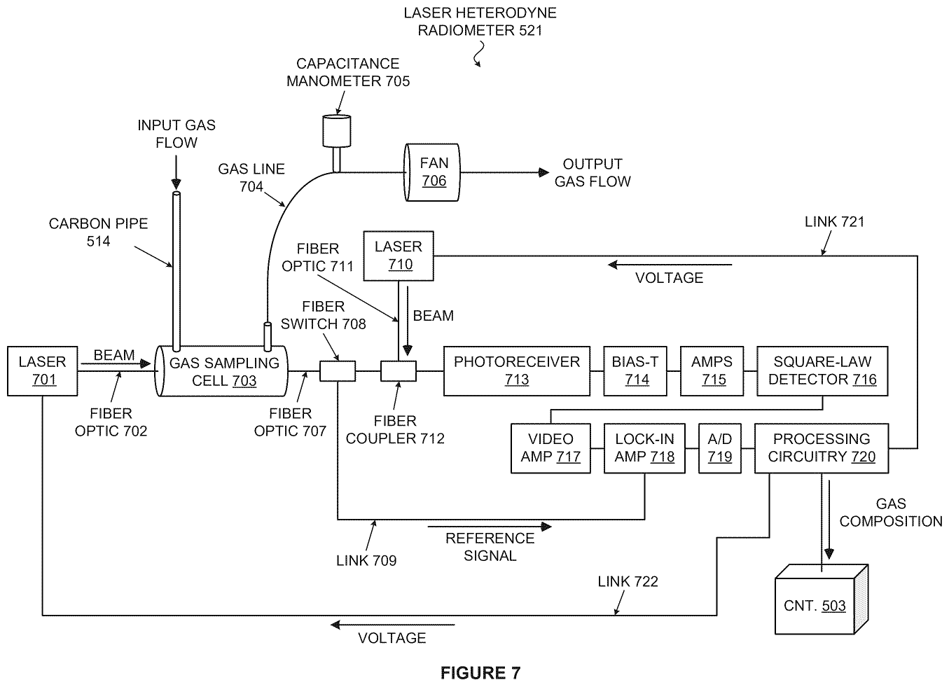

FIG. 7 illustrates laser heterodyne radiometer 521. Laser heterodyne radiometer 521 comprises an example of gas analyzer 103 illustrated in FIG. 1, however gas analyzer 103 may differ. Laser heterodyne radiometer 521 comprises lasers 701 and 710, fiber optics 702, 707, and 711, gas sampling cell 703, gas line 704, capacitance monometer 705, fan 706, fiber switch 708, fiber coupler 712, photoreceiver 713, bias-T 714, amplifiers (AMPS) 715, square-law detector 716, video amplifier 717, lock-in amplifier 718, analog-to-digital converter (A/D) 719, processing circuitry 720, and links 709, 721, and 722. Gas sampling cell 703 is coupled to carbon pipe 514. Processing circuitry 720 is coupled to combustion controller 503. Laser heterodyne radiometer 521 may differ in other examples. In some examples, fan 706 may be replaced (or used in addition with) a pump or other type of device to create a pressure differential.

In some examples, fan 706 is activated (e.g., by combustion controller 503) and pulls exhaust collected by sampling system 510 through carbon pipe 514 and into gas sampling cell 703. As the exhaust is flowing through gas sampling cell 703, laser 701 transfers an infrared beam down fiber optic 702 and into gas sampling cell 703. In gas sampling cell 703, the flowing exhaust gas absorbs a portion of the infrared light emitted from laser 701 in vibrations and rotations of certain molecules. The exhaust gas exists gas sampling cell 703 via gas line 704 and passes through capacitance manometer 705 before being expelled by fan 706. Capacitance monometer 705 is a device to detect the pressure in gas line 704. After passing through gas sampling cell 703, the laser light exits gas sampling cell 703 over fiber optic 707 to fiber switch 708. Fiber switch 708 modulates light and sends an electronic reference signal over link 709 to lock-in amplifier 718 to demodulate the signal. Laser 710 generates a laser beam and transfers the beam to fiber coupler 712. The beam generated by laser 710 is tuned to wavelengths that correspond to the absorption peaks of the chemicals that compose the exhaust gas. It should be appreciated that the wavelength of the beam emitted by laser 710 depends on the chemical that laser heterodyne radiometer 521 is sensing for and may differ in other examples. For example, when configured to detect methane, laser 710 may produce a beam between the wavelengths 1640.2 and 1640.5 nm to capture methane absorption features. The emitted by laser 701 light is superimposed with light from laser 710 in a single mode fiber coupler 712. Fiber coupler 712 attaches fiber optic 711 to fiber optic 707. The two beams travel down fiber optic 707 to photoreceiver 713 which absorbs and mixes the received beams generating a beat signal. The beat signal comprises a Radio Frequency (RF) and Direct Current (DC) output. The RF signal comprises two heterodynes that comprise the sum and the difference between the frequency of the two beams. Photoreceiver 713 transfers the beat signal to bias-T 714 which separates the RF and DC components of the signal. The RF signal is passed to amplifiers 715 which amplify the RF signal and then pass the amplified signal to square-law detector 716 which detects the RF signal. The detected signal is further amplified and low-pass filtered with video amplifier 717.

The output of video amplifier 717 is detected with lock-in amplifier 718 based on the reference signal. The output of lock-in amplifier 718 identifies the amount of absorbed infrared laser light at the absorption peaks for the chemical components (e.g., methane) of the exhaust gas. Analog-to-digital converter 719 converts the output of lock-in amplifier 718 to a digital signal and supplies the digital signal to processing circuitry 720. Both laser 701 and 710 scan in wavelength simultaneously, and molecules in the gas sample absorb light from 701 through their vibrations and rotations. These wavelengths of absorption are known for each molecule and known as “lines” or “absorption features.” The depth of these lines or absorption features can be correlated with the mole fraction (concentration) of the gas in the sample. Scanning laser 701 across the lines (absorption features) and detecting the output produces an absorption spectra. Processing circuitry 720 determines the composition of the exhaust gas and reports the composition to combustion controller 503. Processing circuitry 720 adjusts the voltages supplied to lasers 701 and 710 over links 721 and 722 to modify the wavelength of the beam to sense a new wavelength of the RF signal. Each of lasers 701 and 710 typically receive two input voltages, one that controls temperature and one that controls wavelength. For example, processing circuitry 720 may adjust the wavelengths of lasers 701 and laser 710 to detect nitric oxides in the exhaust.

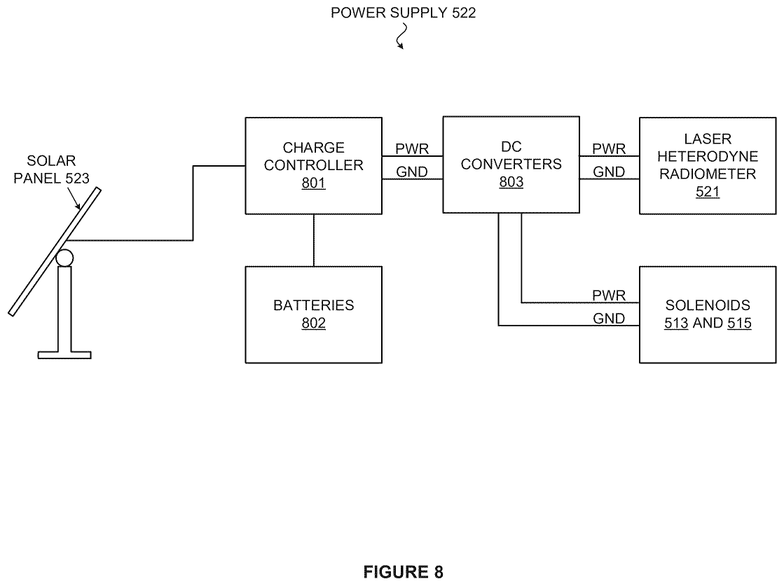

FIG. 8 illustrates power supply 522. Power supply 522 comprises charge controller 801, batteries 802, and DC converters 803. Solar panel 523 absorbs sunlight and generates current. Solar panel 523 supplies the current to charge controller 801. Charge controller 801 distributes the current to batteries 802. When power is required to operate laser heterodyne radiometer 521 or solenoids 513/515, charge controller 801 draws power from batteries 802 and transfers the power to DC converters 803. DC converter 803 up/down convert the current to the necessary voltages and delivers the current to laser heterodyne radiometer 521 and solenoids 513/515. In some examples, solar panel 523 may be replaced by another power source (e.g., a battery, plant auxiliary power, etc.).

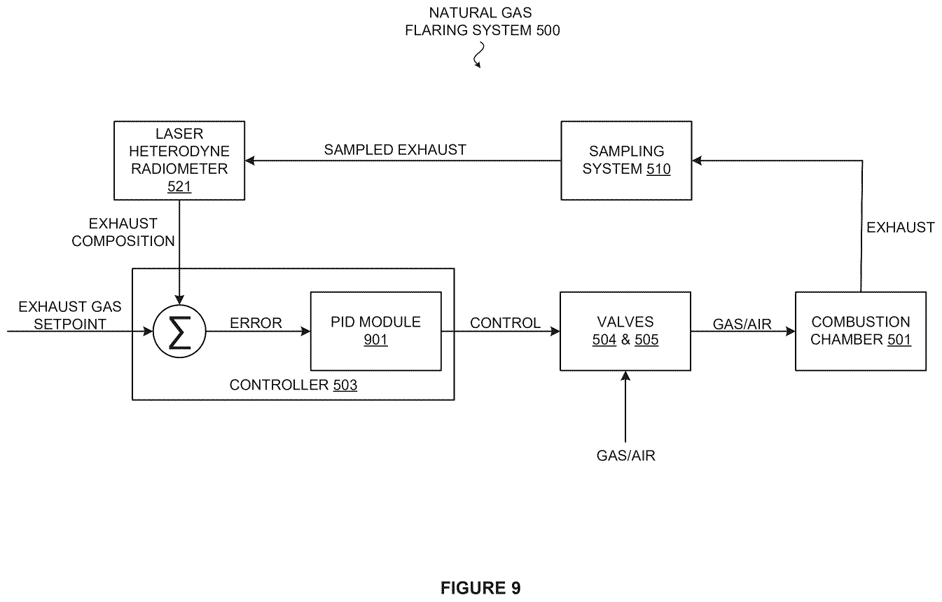

FIG. 9 illustrates an exemplary control loop implemented by combustion controller 503 in natural gas flaring system 500. The processing circuitry of combustion controller 503 hosts PID module 901 to implement the control loop illustrated in FIG. 9. Combustion controller 503 receives an exhaust gas setpoint that indicates the maximum proportion of methane (or other chemicals) in the exhaust gas. Typically, the proportion of methane in the exhaust gas cannot exceed 2%. Combustion controller 503 also receives signaling from laser heterodyne radiometer 521 indicating the chemical composition of the exhaust gas. Combustion controller 503 sums the setpoint and indicated methane proportion to generate an error signal. Combustion controller 503 provides the error signal to PID module 901. PID module 901 generates a control signal and supplies the control signal to valves 504 and 505. The control signal opens/closes valves 504 and/or 505 to adjust the gas/air ratio supplied to combustion chamber 501. Valves 504 and 505 adjust accordingly and supply gas and air to combustion chamber 501 at the new ratio. Combustion chamber 501 ignites the reactants and generates exhaust. Sampling system 510 samples the exhaust. Laser heterodyne radiometer 521 determines the chemical composition of the sampled exhaust and indicates the composition to combustion controller 503. The control loop then repeats.

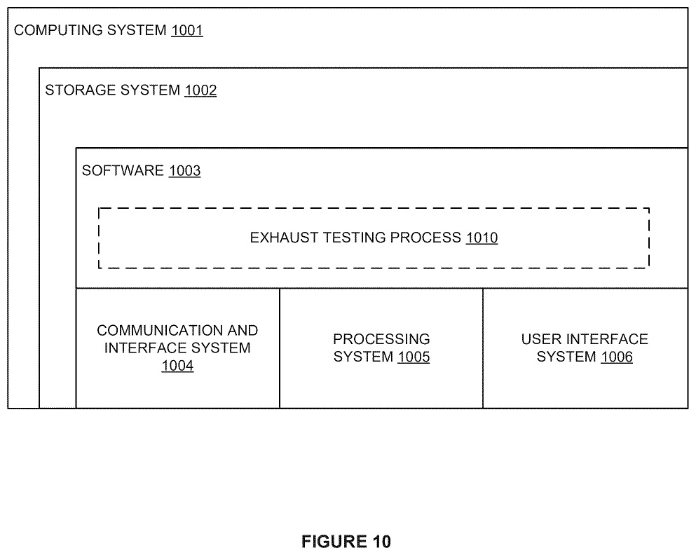

FIG. 10 illustrates computing system 1001. Computing system 1001 is representative of any system or collection of systems with which the various operational architectures, processes, scenarios, and sequences disclosed herein for collecting and characterizing the chemical composition of exhaust gas and for generating control signaling based on the exhaust chemical composition. For example, computing system 1001 may be representative of gas analyzer 103, control system 104, combustion controller 503, laser heterodyne radiometer 521, processing circuitry 720, and/or any other computing device contemplated herein. Computing system 1001 may be implemented as a single apparatus, system, or device or may be implemented in a distributed manner as multiple apparatuses, systems, or devices. Computing system 1001 includes, but is not limited to, storage system 1002, software 1003, communication interface system 1004, processing system 1005, and user interface system 1006. Processing system 1005 is operatively coupled with storage system 1002, communication interface system 1004, and user interface system 1006.

Processing system 1005 loads and executes software 1003 from storage system 1002. Software 1003 includes and implements exhaust testing process 1010, which is representative of any of the exhaust testing processes described with respect to the preceding Figures, including but not limited to the exhaust sampling, exhaust gas characterization, and control operations described with respect to the preceding Figures. For example, process 1010 may be representative of process 300 illustrated in FIG. 3 and/or process 400 illustrated in FIG. 4. When executed by processing system 1005 to sample and characterize exhaust gas, software 1003 directs processing system 1005 to operate as described herein for at least the various processes, operational scenarios, and sequences discussed in the foregoing implementations. Computing system 1001 may optionally include additional devices, features, or functionality not discussed for purposes of brevity.

Processing system 1005 may comprise a micro-processor and other circuitry that retrieves and executes software 1003 from storage system 1002. Processing system 1005 may be implemented within a single processing device but may also be distributed across multiple processing devices or sub-systems that cooperate in executing program instructions. Examples of processing system 1005 include general purpose CPUs, GPUs, DSPs, ASICs, FPGAs, analog computing devices, and logic devices, as well as any other type of processing device, combinations, or variations thereof.

Storage system 1002 may comprise any computer readable storage media readable by processing system 1005 and capable of storing software 1003. Storage system 1002 may include volatile, nonvolatile, removable, and/or non-removable media implemented in any method or technology for storage of information, such as computer readable instructions, data structures, program modules, or other data. Examples of storage media include RAM, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1002 may also include computer readable communication media over which at least some of software 1003 may be communicated internally or externally. Storage system 1002 may be implemented as a single storage device but may also be implemented across multiple storage devices or sub-systems co-located or distributed relative to each other. Storage system 1002 may comprise additional elements, such as a controller, capable of communicating with processing system 1005 or possibly other systems.

Software 1003 (including process 1010) may be implemented in program instructions and among other functions may, when executed by processing system 1005, direct processing system 1005 to operate as described with respect to the various operational scenarios, sequences, and processes illustrated herein. For example, software 1003 may include program instructions for generating control signaling to adjust the fuel/air ratio supplied to a combustion chamber based on exhaust gas chemical composition as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1003 may include additional processes, programs, or components, such as operating system software, virtualization software, or other application software. Software 1003 may also comprise firmware or some other form of machine-readable processing instructions executable by processing system 1005.

In general, software 1003 may, when loaded into processing system 1005 and executed, transform a suitable apparatus, system, or device (of which computing system 1001 is representative) overall from a general-purpose computing system into a special-purpose computing system customized to sample and characterize exhaust gas. Indeed, encoding software 1003 on storage system 1002 may transform the physical structure of storage system 1002. The specific transformation of the physical structure may depend on various factors in different implementations of this description. Examples of such factors may include, but are not limited to, the technology used to implement the storage media of storage system 1002 and whether the computer-storage media are characterized as primary or secondary storage, as well as other factors.

For example, if the computer readable storage media are implemented as semiconductor-based memory, software 1003 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1004 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and an extended discussion of them is omitted for the sake of brevity.

While some examples provided herein are described in the context of computing devices for exhaust gas testing, it should be understood that the condition systems and methods described herein are not limited to such embodiments and may apply to a variety of other environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims

What is claimed is:

1. An exhaust testing system to characterize exhaust gas composition, the exhaust testing system comprising:
a sampling system coupled to an exhaust stack of a combustion system, the sampling system comprising:
a cage mounted to an opening of the exhaust stack;
sampling pipes mounted to the cage and configured to capture exhaust gas generated by the combustion system and emitted through the opening of the exhaust stack; and
valves configured to control gas flow through the sampling pipes; and
a gas analyzer coupled to the sampling pipes and configured to determine gas composition of the exhaust gas.

2. The exhaust testing system of claim 1 further comprising a control system; and wherein:
the gas analyzer is configured to indicate the gas composition of the exhaust gas to the control system; and
the control system is configured to adjust an input gas composition of the combustion system based on the gas composition.

3. The exhaust testing system of claim 2 wherein:
the gas composition indicates one or more unreacted reaction inputs and/or one or more undesired reaction side products; and
the control system is configured to adjust the input gas composition of the combustion system based on the gas composition to reduce an amount of the one or more unreacted reaction inputs and/or the one or more undesired reaction side products in the exhaust gas.

4. The exhaust testing system of claim 3 wherein:
the one or more unreacted reaction inputs comprise one or more of natural gas, methane (CH₄), ethane (C₂H₆), propane (C₃H₈), and butane (C₄H₁₀);
the one or more undesired reaction side products comprise one or more of carbon monoxide (CO), nitric oxides (NO_{X}), hydrogen sulfide (H₂S), and sulfur oxides (SO_{X}); and
the input gas composition comprises a mixture of air and natural gas.

5. The exhaust testing system of claim 1 wherein:
the sampling pipes comprise different lengths and extend over the opening of the exhaust stack; and
the sampling pipes are configured to capture the exhaust gas generated by the combustion system and emitted through the opening of the exhaust stack at different points along a cross-section of the opening of the exhaust stack.

6. The exhaust testing system of claim 1 further comprising a control system; and wherein:
the sampling pipes comprise different lengths and extend over the opening of the exhaust stack;
the control system is configured to transfer control signaling to open a first one of the valves that controls gas flow through a first one of the sampling pipes and to close remaining ones of the values that control gas flow through remaining ones of the sampling pipes;
the first one of the sampling pipes is configured to capture the exhaust gas emitted at a first point along a cross-section of the opening of the exhaust stack;
the gas analyzer is configured to determine a first gas composition of the exhaust gas emitted at the first point along the cross-section of the opening of the exhaust stack;
the control system is configured to transfer control signaling to close the first one of the valves that controls gas flow through the first one of the sampling pipes and to open one of the remaining ones of the values that control gas flow through one of the remaining ones of the sampling pipes;
the one of the remaining ones of the sampling pipes is configured to capture the exhaust gas emitted at a second point along the cross-section of the opening of the exhaust stack; and
the gas analyzer is configured to determine a second gas composition of the exhaust gas emitted at the second point along the cross-section of the opening of the exhaust stack.

7. The exhaust testing system of claim 1 wherein the gas analyzer comprises a laser heterodyne radiometer.

8. The exhaust testing system of claim 1 wherein the cage comprises a conical steel frame.

9. The exhaust testing system of claim 1 wherein the sampling pipes comprise one or more of carbon pipes or quartz tubes.

10. The exhaust testing system of claim 1 wherein the valves comprise one or more of solenoids or ball valves.

11. The exhaust testing system of claim 1 further comprising a control system configured to:
open and close the valves; and
to control an input gas composition of the combustion system based on the gas composition.

12. The exhaust testing system of claim 11 wherein the control system comprises one or more of a Proportional Integral Derivative (PID) controller, a Programmable Logic Controller (PLC), or a machine learning based controller.

13. The exhaust testing system of claim 1 further comprises a power system configured to provide electrical power to the gas analyzer and the valves; and wherein:
the power system comprises a power source and a power supply;
the power source is configured to provide the electrical power; and
the power supply is configured to control voltage of the electrical power to the gas analyzer and the valves.

14. The exhaust testing system of claim 13 wherein the power source comprises one or more of a solar panel, a battery, or a plant auxiliary power.

15. A method of operating an exhaust testing system to characterize exhaust gas composition, the method comprising:
capturing, by sampling pipes attached to a cage mounted to an exhaust stack of a combustion system, exhaust gas from the combustion system;
providing, by the sampling pipes, the exhaust gas to a gas analyzer;
determining, by the gas analyzer, a composition of the exhaust gas;
indicating, by the gas analyzer, the composition of the exhaust gas to a controller; and
adjusting, by the controller, an input gas composition to the combustion system based on the composition of the exhaust gas.

16. The method of claim 15 wherein the sampling pipes comprise different lengths and extend to different points along a cross-section of an opening of the exhaust stack; and further comprising:
transferring, by the controller, signaling to open a first valve that controls gas flow through a first one of the sampling pipes and to close other valves that control gas flow through remaining ones of the sampling pipes; and wherein:
capturing, by sampling pipes, exhaust gas from the combustion system comprises capturing, by the first one of the sampling pipes, the exhaust gas from a first point along the cross-section of the opening of the exhaust stack;
providing, by the sampling pipes, the exhaust gas to the gas analyzer comprises providing, by the first one of the sampling pipes, the exhaust gas captured from the first point along the cross-section of the opening of the exhaust stack to the gas analyzer; and
determining, by the gas analyzer, the composition of the exhaust gas comprises determining, by the gas analyzer, the composition of the exhaust gas at the first point along the cross-section of the opening of the exhaust stack.

17. The method of claim 16 further comprising:
transferring, by the controller, additional signaling to close the first valve that controls gas flow through the first one of the sampling pipes and to open a second valve of the other valves that controls gas flow through a second one of the sampling pipes;
capturing, by the second one of the sampling pipes, the exhaust gas from a second point along the cross-section of the opening of the exhaust stack;
providing, by the second one of the sampling pipes, the exhaust gas captured from the second point along the cross-section of the opening of the exhaust stack to the gas analyzer; and
determining, by the gas analyzer, the composition of the exhaust gas at the second point along the cross-section of the opening of the exhaust stack.

18. The method of claim 15 wherein:
the gas composition indicates one or more unreacted reaction inputs and/or one or more undesired reaction side products; and
adjusting, by the controller, the input gas composition to the combustion system based on the composition of the exhaust gas comprises adjusting, by the controller, the input gas composition to the combustion system based on the composition of the exhaust gas to reduce an amount of the one or more unreacted reaction inputs and/or the one or more undesired reaction side products in the exhaust gas.

19. The method of claim 18 wherein:
the one or more unreacted reaction inputs comprise one or more of natural gas, methane (CH₄), ethane (C₂H₆), propane (C₃H₈), and butane (C₄H₁₀);
the one or more undesired reaction side products comprise one or more of carbon monoxide (CO), nitric oxides (NO_{X}), hydrogen sulfide (H₂S), and sulfur oxides (SO_{X}); and
the input gas composition comprises a mixture of air and natural gas.

20. One or more non-transitory computer-readable media stored thereon instructions to control exhaust gas composition of a combustion system, that, in response to execution, cause a computing device comprising a processor to perform operations, the operations comprising:
obtaining, from a laser heterodyne radiometer, a measurement that indicates a proportion of unreacted natural gas in exhaust gas generated by the combustion system wherein the laser heterodyne radiometer receives the exhaust gas captured by carbon sampling pipes attached to a conical steel cage mounted to an opening of an exhaust stack of the combustion system and measures the proportion of unreacted natural gas in the exhaust gas;
comparing the proportion of unreacted natural gas in the exhaust gas to a threshold that indicates a maximum allowable proportion of unreacted natural gas in the exhaust gas;
determining that the proportion of unreacted natural gas in the exhaust gas exceeds the threshold based on the comparison;
generating signaling to adjust an input fuel-to-air ratio for the combustion system to reduce the proportion of unreacted natural gas in the exhaust gas; and
transferring the signaling for delivery to the combustion system wherein the combustion system adjusts the input fuel-to-air ratio based on the signaling.
